(19) United States
(12) Patent Application Publication
(10) Pub. No.: US 2021/0403054 A1
(43) Pub. Date: Dec. 30, 2021

(54) VEHICLE ALLOCATION METHOD IN AUTOMATED VEHICLE AND HIGHWAY SYSTEM AND APPARATUS THEREFOR

(71) Applicant: LG Electronics Inc., Seoul (KR)

(72) Inventor: Soryoung KIM, Seoul (KR)

(21) Appl. No.: 16/493,556

(22) PCT Filed: Jul. 31, 2019
(86) PCT No.: PCT/KR2019/009584

§ 371 Date: Sep. 12, 2019

(51) Int. Cl. B60W 60/00; H04L 29/08; G16Y 10/75; G16Y 10/40; B60W 50/14; G06N 3/08

(52) U.S. Cl. CPC B60W 60/00253; H04L 67/12; G16Y 10/75; G16Y 10/40; B60W 50/14; B60W 2540/045; B60W 2540/215; B60W 2556/45; B60W 2540/043; B60W 2520/10; B60W 2520/12; G06N 3/08

(57) ABSTRACT

Disclosed is a vehicle allocation method of a server in an automated vehicle and highway system, which acquires a state information of a user, using a home Internet of Things (IoT), determines behavior information of the user, sets a going out stage related to an action sequence for going out of the user, based on the behavior information, transmits a vehicle allocation request message to the vehicle in order for the user to use the vehicle, based on the going out stage, whereby efficient vehicle allocation can be provided to users. One or more of an autonomous vehicle, a user terminal and a server may be connected to an artificial intelligence (AI) module, a drone (unmanned aerial vehicle, UAV) robot, an augmented reality (AR) apparatus, a virtual reality (VR) apparatus, a 5G service related apparatus or the like.

### TECHNICAL FIELD

The invention relates to an automated vehicle & highway system, and to a vehicle allocation method using a home Internet of Things (IoT), and an apparatus therefor.

### BACKGROUND ART

Vehicles may be classified into internal combustion engine vehicles, external combustion engine vehicles, gas turbine vehicles and electric vehicle based on an engine type used therein.

An autonomous vehicle refers to a vehicles capable of driving by itself without operation of a driver or a passenger, and an automated vehicle & highway system refers to a system which monitors and controls so as to allow such autonomous vehicle to drive by itself.

### DISCLOSURE

### Technical Problem

The invention has been made in an effort to address aforementioned necessities and/or problems.

Further, one embodiment of the disclosure is directed to a vehicle allocation method in an automated vehicle and highway system, and an apparatus therefor.

Further, another embodiment of the disclosure proposes to a user an efficient vehicle allocation method using a home IoT in an automated vehicle and highway system, and an apparatus therefor.

Technical problems, which the invention is to address, are limited to the aforementioned technical problems, and unmentioned or other technical problems may be understood from the following detailed description by a person having an ordinary skill in the art to which the invention belongs.

### Technical Solution

According to an aspect of the invention, there is provided a vehicle allocation method of a server in an automated vehicle and highway system, the vehicle allocation method including: acquiring state information of a user, using a home Internet of Things (IoT); extracting a characteristic value from the state information; inputting the characteristic value into a learned deep neural network (DNN) classifier, and determining behavior information of the user from an output of the deep neural network; setting a going out stage related to an action sequence for going out of the user, based on the behavior information; and transmitting a vehicle allocation request message to the vehicle in order for the user to use the vehicle, based on the going out stage, wherein the vehicle allocation request message may be transmitted through a V2X message, and contain a movement request message for moving the vehicle.

Additionally, the state information may include location information of the user, thing information of a space in which the user is located, and information indicating whether the user uses the thing, and may be periodically generated via the home Internet of Things (IoT).

Additionally, the going out stage may include a first stage indicating that the user is prior to start of going out preparation, a second stage indicating that the going out preparation is in progress, or a third stage indicating that the going out preparation is completed.

Additionally, the movement request message may indicate a movement toward a point within a predetermined distance range from a location point of the user, based on the going out stage.

Additionally, the second stage may be set in a case where it is determined that the user performed one or more actions related to the action sequence.

Additionally, in a case where the going out stage is updated, the predetermined distance range may indicate a predetermined distance range that is closer from the location point of the user than the predetermined distance range indicated at the previous going out stage.

Additionally, in a case where the going out stage is set to the third stage, the vehicle allocation method may further include transmitting a message asking whether to board the vehicle or not to a terminal of the user; and receiving a response message to the message asking whether to board or not, wherein the usage information of the user may be updated, based on the response messages.

Additionally, in a case where the response message indicates boarding rejection of the user, the vehicle may be set to an idle vehicle.

Additionally, in a case where the response message indicates boarding acceptance of the user, the vehicle allocation method may further includes transmitting information on a boarding location of the vehicle, information of the vehicle, usage fee of the vehicle, a travel distance or a necessary time to the user's destination to the terminal.

Additionally, the vehicle allocation method may further include determining clothes information of the user based on the state information, using the above DNN model; and setting a priority value of the vehicle related to the clothes information, wherein the setting of the priority value may set the higher the priority value for a vehicle of a vehicle type at a higher class as the clothes of the user is more formal.

According to another aspect of the invention, there is provided a server providing a vehicle allocation method in an automated vehicle and highway system, the server including: a communication module; a memory; a processor, wherein the processor acquires state information of a user, using a home Internet of Things (IoT), extracts s characteristic value from the state information, inputs the characteristic value into a learned deep neural network (DNN) classifier, and determines behavior information of the driver from an output of the deep neural network, sets a going out stage related to an action sequence for going out of the user, based on the behavior information, and transmits a vehicle allocation request message to the vehicle in order for the user to use the vehicle, through the communication module, based on the going out stage, wherein the vehicle allocation request message may be transmitted through a V2X message, and contain a movement request message for moving the vehicle.

### Advantageous Effects

According to an example, it is possible to provide a vehicle allocation method in an automated vehicle and highway system, and an apparatus therefor.

Further, according to another example of the disclosure, it is possible for a server in an automated vehicle and highway system to provide to a user an efficient vehicle allocation method using a home IoT, and an apparatus therefor.

Advantageous effects, which the invention may provide, are limited to the aforementioned ones, and unmentioned or other ones may be understood from the following detailed description by a person having an ordinary skill in the art to which the invention belongs.

### DESCRIPTION OF DRAWINGS

FIG. 1 exemplifies a block diagram of a wireless communication system to which methods proposed herein may be applied.

FIG. 2 is a drawing illustrating an example of a signal transmitting/receiving method in a wireless communication system.

FIG. 3 shows an example of the basic operation of a 5G network and a user terminal in a 5G communication system.

FIG. 4 is a drawing showing a vehicle according to an example of the disclosure.

FIG. 5 is a block diagram of AI apparatus according to an example of the disclosure.

FIG. 6 is a drawing for illustrating a system to which an autonomous vehicle and an AI apparatus are connected, according to an example of the invention.

FIG. 7 is an example of the DNN model to which the invention may be applied.

FIG. 8 is an example to which the invention may be applied.

FIG. 9 is an example to which the invention may be applied.

FIG. 10 is a drawing showing a configuration of a server to which the invention is applied.

Attached drawings, which are included as a part of the detailed description to facilitate understanding of the invention, provide examples of embodiments for the invention, and describe technical features of the invention altogether with the detailed description.

### MODE FOR INVENTION

Hereinafter, exemplary embodiments disclosed herein will be described with reference to attached drawings, in which identical or like components are given like reference numerals regardless of reference symbols, and repeated description thereof will be omitted. Suffixes for components, “module” and “unit” used in the following description, will be given or used in place of each other taking only easiness of specification preparation into consideration, and they do not have distinguishable meanings or roles by themselves. Additionally, it is noted that the detailed description for related prior arts may be omitted herein so as not to obscure essential points of the disclosure. Further, the attached drawings are intended to facilitate the understanding of examples disclosed herein, and the technical spirit disclosed herein is not limited by the attached drawings, and rather should be construed as including all the modifications, equivalents and substitutes within the spirit and technical scope of the invention.

The terms including ordinal number such as, first, second and the like may be used to explain various components, but the components are not limited by the terms. Said terms are used in order only to distinguish one component from another component.

Further, when one element is referred to as being “connected” or “accessed” to another element, it may be directly connected or accessed to the other element or intervening elements may also be present as would be understood by one of skill in the art. On the contrary, when one element is referred to as being “directly connected” or “directly accessed” to another element, it should be understood as that the other element is not present between them.

Singular expression includes plural expression unless explicitly stated to the contrary in the context.

Herein, it should be understood that the terms “comprise,” “have,” “contain,” “include,” and the like are intended to specify the presence of stated features, numbers, steps, actions, components, parts or combinations thereof, but they do not preclude the presence or addition of one or more other features, numbers, steps, actions, components, parts or combinations thereof.

Hereinafter, autonomous driving apparatus requiring AI processed information, and/or 5th generation mobile communication which an AI processor requires will be described through sections A to G.

A. Example of UE and Network Block Diagram

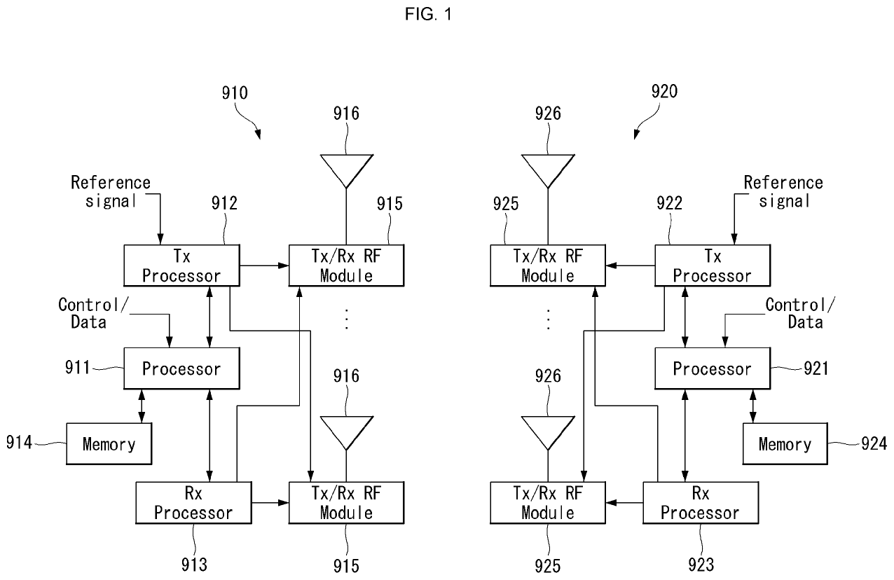

FIG. 1 exemplifies a block diagram of a wireless communication system to which methods proposed herein may be applied.

Referring to FIG. 1, an apparatus (AI apparatus) including an AI module may be defined as a first communication apparatus (910 in FIG. 1), and a processor 911 may perform an AI specific action.

5G network including another apparatus (AI server) communicating with the AI apparatus may be as a second communication apparatus (920 in FIG. 1), and a processor 921 may perform an AI specific action.

The 5G network may be denoted as the first communication apparatus, and the AI apparatus may be denoted as the second communication apparatus.

For example, the first communication apparatus or the second communication apparatus may be a base station, a network node, a transmission terminal, a wireless apparatus, a wireless communication apparatus, a vehicle, a vehicle loaded with a autonomous driving function, a connected car, a drone (unmanned aerial vehicle, UAV), an artificial intelligence (AI) module, a robot, an augmented reality (AR) apparatus, a virtual reality (VR) apparatus, a mix reality apparatus, a hologram apparatus, a public safety apparatus, an MTC apparatus, an IoT apparatus, a medical apparatus, a fintech apparatus (or financial apparatus), a security apparatus, a climate/environmental apparatus, 5G service related apparatus or 4th industrial revolution field related apparatus.

For example, the terminal or user equipment (UE) may include a mobile phone, a smart phone, a laptop computer, a digital broadcasting terminal, a personal digital assistant (PDA), a portable multimedia player (PMP), a navigation, a slate PC, a tablet PC, a wearable devices, e.g., a smartwatch, a smartglass, a head mounted display (HMD), or the like. For example, the HMD may be a display apparatus which is worn an the head. For example, the HMD may be used to embody VR, AR or MR. For example, the drone may be a flying object which is flown by wireless control signals without a human on board. For example, the VR apparatus may include an apparatus for embodying an object or background of a virtual world. For example, the AR apparatus may include an apparatus which embodies by connecting an object or background of a virtual world to an object or background of a real world. For example, the MR apparatus may include an apparatus which embodies by fusing an object or background of a virtual world to an object or background of a real world. For example, the hologram apparatus may include an apparatus which embodies a hologram, i.e., 360 degree three-dimensional image, by recording and replaying three-dimensional information, utilizing Interference phenomenon of light produced when two laser lights meet. For example, the public safety apparatus may include an image relay apparatus or an imaging apparatus which is wearable onto the body of a user. For example, the MTC apparatus and the IoT apparatus may be an apparatus which does not require direct intervention or operation of a human. For example, the MTC apparatus and the IoT apparatus may include smart meters, bending machines, thermometers, smart light bulbs, door locks, various sensors or the like. For example, the medical apparatus may be an apparatus used to diagnose, cure, mitigate, treat, or prevent diseases. For example, the medical apparatus may be an apparatus used to diagnose, cure, mitigate or correct injuries or disabilities. For example, the medical apparatus may be an apparatus used for the purpose of inspecting, replacing, or transforming a structure or function. For example, the medical apparatus may be an apparatus used for the purpose of controlling pregnancy. For example, the medical apparatus may include medical devices, surgical devices, (in vitro) diagnostic devices, hearing aids, medical procedure devices or the like. For example, the security device may be a device installed to prevent danger that may occur and to maintain safety. For example, the security device may be cameras, CCTVs, recorders, black boxes or the like. For example, the fintech apparatus may be devices that can provide financial services such as mobile payments or the like.

Referring to FIG. 1, the first communication apparatus 910 and the second communication apparatus 920 include processors 911,921, memories 914,924, Tx/Rx radio frequency (RF) modules 915,925, Tx processors 912,922, Rx processors 913,923, antennas 916,926. The Tx/Rx module may be referred to as a transceiver. Each of Tx/Rx modules 915 transmits signals toward each of antennas 926. The processor embodies the function, the process and/or the method described above. The processor 921 may be associated with a memory (924) which store program code and data. The memory may be referred to as a computer readable medium. More specifically, in DL (communication from the first communication apparatus to the second communication apparatus), the transmission TX processor 912 embodies various signal processing functions for a L1 layer (i.e., physical layer). The RX processor embodies various signal processing functions of the L1 (i.e., physical layer).

UL (communication from the second communication apparatus to the first communication apparatus) is processed in the first communication apparatus 910 in a similar way as described in connection with the receiving function in the second communication apparatus 920. Each of the Tx/Rx modules 925 receives signals via each of the antennas 926. Each of the Tx/Rx modules provides RF carrier and information to the Rx processor 923. The processor 921 may be associated with a memory (924) which store program code and data. The memory may be referred to as a computer readable medium.

According to an example of the disclosure, the first communication apparatus may be a vehicle, and the second communication apparatus may be a 5G network.

B. Signal Transmitting/Receiving Method in Wireless Communication System

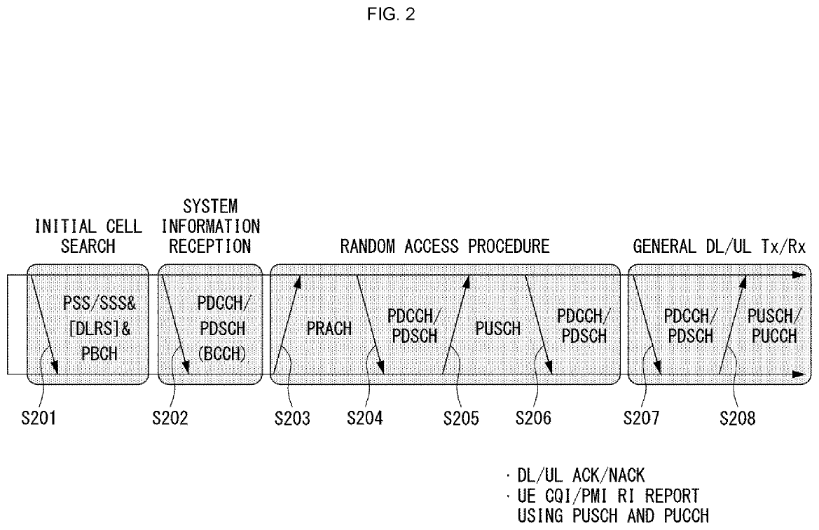

FIG. 2 is a drawing illustrating an example of a signal transmitting/receiving method in a wireless communication system.

Referring to FIG. 2, UE performs initial cell search tasks of synchronizing with BS or the like when turning on power or entering a new cell (S201). For this, UE may receive a primary synchronization channel (P-SCH) and a secondary synchronization channel (S-SCH) to be synchronized with BS and acquire information such as cell ID and the like. In a LTE system and a NR system, the P-SCH and the S-SCH are referred to as a primary synchronization signal (PSS) and a secondary synchronization signal (SSS), respectively. After the initial cell search, UE may receive a physical broadcast channel (PBCH) to acquire broadcast information within a cell. Meanwhile, UE may receive a downlink reference Signal (DL RS) at the initial cell search stage to check a downlink channel state. After finishing the initial cell search, UE may acquire more specific system information by receiving a physical downlink control channel (PDCCH) and a physical downlink shared channel (PDSCH) according to information carried by the PDCCH (S202).

Meanwhile, UE may perform a random access procedure (RACH) to BS when there is no wireless resource for initial access or signal transmission to BS (Steps S203 to S206). For this, UE may transmit a certain sequence as a preamble via a physical random access Channel (PRACH) (S203 and S205), and receive a random access response (RAR) message for the preamble via PDCCH and corresponding PDSCH (S204 and S206). In a case of a contention based RACH, a contention resolution procedure may be further performed.

After performing procedures described above, UE may perform PDCCH/PDSCH reception (S207), and physical uplink shared Channel (PUSCH)/physical uplink control channel (PUCCH) transmission (S208) as a general uplink/downlink signal transmission procedure. Particularly, UE receives downlink control information (DCI) via PDCCH. UE monitors a set of PDCCH candidates on monitoring occasions configured in one or more control element sets (CORESET) on a serving cell according to corresponding search space configurations. The set of PDCCH candidates to be monitored by UE may be defined in terms of search space sets, and the search space set may be a common search space set or an UE specific search space set. CORESET is configured with a set of (physic) resource blocks having time duration of 1 to 3 OFDM symbols. The network may be configured, such that UE has a plurality of CORESET. UE monitors PDCCH candidates in one or more search space sets. Here, monitoring means trying to decode PDCCH candidates in the search space. When UE succeeds in decoding one of the PDCCH candidates in the search space, the UE determines that PDCCH has been searched from corresponding PDCCH candidates, and performs PDSCH reception or PUSCH transmission based on DCI in detected PDCCH. PDCCH may be used to schedule DL transmission on PDSCH and UL transmissions on PUSCH. Here, DCI on PDCCH has a downlink assignment (i.e. downlink grant; DL grant), which at least includes the modulation and coding format and the resource allocation information associated with the downlink share channel, or uplink grant (UL grant) that contains the modulation and coding format and the resource allocation information associated with the uplink share channel.

Referring to FIG. 2, the initial access (IA) procedure in the 5G communication system will be further discussed.

UE may perform cell search, system information acquisition, beam alignment for initial access, DL measurement, and the like based on SSB. SSB is used mixed with a Synchronization Signal/Physical Broadcast channel (SS/PBCH) block.

SSB is configured with PSS, SSS and PBCH. SSB is configured in four continuous OFDM symbols, and PSS, PBCH, SSS/PBCH or PBCH is transmitted according to OFDM symbols. PSS and SSS are respectively configured with one OFDM symbol and 127 subcarriers, and PBCH is configured with three OFDM symbol and 576 subcarriers.

Cell search means a procedure in which UE acquires time/frequency of a cell, and detects cell ID (Identifier) (e.g., Physical layer Cell ID (PCI)) of the cell. PSS is used to detects the cell ID in a cell ID group, and SSS is used to detect a cell ID group. PBCH is used to detect SSB (time) index and a half-frame.

There are 336 cell ID groups and 3 cell IDs per cell ID group. There are 1008 cell IDs in total. Information on the cell ID group which the cell ID of the cell belongs to is provided/acquired via SSS of the cell, and information on the cell ID among 336 cells in the cell ID is provided/acquired via PSS.

SSB is periodically transmitted to SSB periodicity. At the initial cell search, SSB basic periodicity assumed by UE is defined as 20 ms. After cell access, SSB periodicity may be configured to be one of {5 ms, 10 ms, 20 ms, 40 ms, 80 ms, 160 ms} by the network (e.g., BS).

Next, the system information (SI) acquisition will be described.

SI is divided into a master information block (MIB) and a plurality of system information blocks (SIBs). SI other than MIB may be referred to as Remaining Minimum System Information (RMSI). MIB includes information/parameter for monitoring of PDCCH which schedules PDSCH carrying SIB1 (SystemInformationBlock1), and is transmitted by BS via PBCH of SSB. SIB1 includes information associated with the availability and scheduling (e.g., transmission cycles, SI-Windows sizes) of the remaining SIBs (hereinafter, referred to as SIBx, where x is an integer equal to or greater than 2). SIBx is included in SI message and transmitted via the PDSCH. Each SI message is transmitted within a periodically occurring time window (i.e., SI-Window).

Referring to FIG. 2, a random access (RA) process in the 5G communication system will be further discussed.

The random access process is used for a variety of purposes. For example, the random access process may be used for network initial access, handover and UE-triggered UL data transmission. UE may acquire UL synchronization and UL transmission resources through the random access process. The random access process is divided into a content-based random access process and a contention free random access process. Specific procedure for the contention based random access process is as follows.

UE may transmit the random access preamble as Msg1 of the random access process in UL via PRACH. Random access preamble sequences having two lengths different from each other are supported. The long sequence length 839 is applied to subcarrier spacing of 1.25 and 5 kHz, while the short sequence length 139 is applied to subcarrier spacing of 15, 30, 60 and 120 kHz.

When BS receives the random access preamble from UE, BS transmits the random access response (RAR) message (Msg2) to the UE. PDCCH, which schedules PDSCH carrying RAR, is CRC-masked by a random access (RA) wireless network temporary identifier (RNTI) (RA-RNTI) and transmitted. The UE which detects PDCCH masked by RA-RNTI may receive RARs from PDSCH which is scheduled by the DCI carried by the PDCCH. The UE checks that the random access response information for the preamble which has been transmitted by itself, i.e. Msg1, is within the RAR. Whether there is any random access information for Msg1 which has been transmitted by itself may be determined by whether there is a random access preamble ID for the preambles which has been transmitted by the UE. In the absence of a response to Msg1, the UE may retransmit the RACH preamble within a limited number of times while performing power ramping. The UE calculates the PRACH transmission power for retransmissions of the preamble based on the most recent path loss and power ramp counter.

Based on the random access response information, the UE may transmit UL transmission over the uplink sharing channel as Msg3 of the random access process. Msg3 may include RRC connection requests and UE identifiers. As a response to Msg3, the network may transmit Msg4, which may be treated as a contention resolution message on the DL. By receiving Msg4, the UE may enter into a RRC-connected state.

C. Beam Management (BM) Procedure of 5G Communication System

A BM process may be divided into (1) a DL BM process using SSB or CSI-RS, and (2) an UL BM process using SRS (sound reference signal). In addition, each BM process may include Tx beam sweeping to determine the Tx beam and Rx beam sweeping to determine the Rx beam.

DL BM process using SSB will now be described.

The setting for beam report using SSB is performed at channel state information (CSI)/beam setting in RRC_CONNECTED.
UE receives from BS, CSI-ResourceConfig IE containing CSI-SSB-ResourceSetList for SSB resources used for BM. The RRC parameter csi-SSB-ResourceSetList represents a list of SSB resources used for beam management and reporting in a set of resources. Here, the SSB resource set may be configured to be {SSBx1, SSBx2, SSBx3, SSBx4, . . . }. An SSB index may be defined as from 0 to 63.
The UE receives signals on SSB resources from the BS based on the CSI-SSB-ResourceSetList.
If CSI-RS reportConfig associated with reporting of SSBRI and reference signal received power (RSRP) is established, the UE reports best SSBRI and RSRP corresponding to it to BS. For example, if the reportQuantity of the CSI-RS reportConfig IE is set to ‘ssb-Index-RSRP’, the UE reports the best SSBRI and RSRP corresponding to it to BS.

If CSI-RS resources are set to same OFDM symbol(s) as SSB, and ‘QCL-TypeD’ is applicable, the UE may assume that CSI-RS and SSB are quasi co-located (QCL) from a point of view of the ‘QCL-TypeD’. Here, QCL-TypeD may mean being QCL between antenna ports from a point of view of a spatial Rx parameter. The same receive beam may be applied when the UE receives signals from multiple DL antenna ports in the QCL-TypeD relationship.

Next, DL BM process using CSI-RS will now be described.

The Rx beam determination (or refinement) process of the UE using CSI-RS and the Tx beam swiping process of the BS will be are discussed in order. The Rx beam determination process of UE is set for a repetition parameter to be ‘ON’, and the Tx beam swiping process of BS is set for the repetition parameter to be ‘OFF’.

First, the Rx beam determination process of the UE will be described.
The UE receives NZP CSI-RS resource set IE, which includes RRC parameters for ‘repetition’, from the BS through RRC signalling. Here, the RRC parameter ‘repetition’ is set to be ‘ON’.
The UE repeatedly receives from OFDM symbols different from each other via the same Tx beam of the BS (or DL space domain transmission filter), signals on the resource(s) in the CSI-RS resource set in which the RRC parameter ‘repetition’ is set to be ‘ON’.
UE determines its RX beam.
The UE omits the CSI report. That is, if the RRC parameter ‘repetition’ is set to be ‘ON’, the CSI report may be omitted.

Next, the Rx beam determination process of the BS will be described.
The UE receives NZP CSI-RS resource set IE, which includes RRC parameters for ‘repetition’, from the BS through RRC signalling. Here, the RRC parameter ‘repetition’ is set to be ‘OFF’, and associated with the Tx beam sweeping process of BS.
The UE receives via the Tx beams of the BS different from each other (or DL space domain transmission filter), signals on the resources in the CSI-RS resource set in which the RRC parameter ‘repetition’ is set to be ‘OFF’.
The UE selects (or determines) the best beam.
The UE reports the ID (e.g., CRI) and related quality information (e.g., RSRP) for the selected beam to BS. That is, the UE reports the CRI and RSRP for it to BS when CSI-RS is transmitted for BM.

Next, UL BM process using SRS will now be described.
The UE receives from the BS an RRC signalling (e.g., SRS-Config IE) containing the (RRC parameter) usage parameters set to ‘beam management’. The SRS-Config IE is used for SRS transmission configuration. SRS-Config IE includes a list of SRS-Resources and a list of SRS-ResourceSets. Each SRS resource set means a set of SRS-resources.
The UE determines Tx beamforming for SRS resources to be transmitted based on the SRS-SpatialRelation Info included in SRS-Config IE. Here, the SRS-SpatialRelation Info is set for each SRS resources and indicates whether to apply the same beamforming as that used in SSB, CSI-RS, or SRS for each SRS resource.
If SRS-SpatialRelationInfo is set for an SRS resource, same beamforming as that used in SSB, CSI-RS, or SRS is applied and transmitted. However, if SRS-SpatialRelationInfo is not set in the SRS resource, the UE arbitrarily determines the Tx beamforming and transmits the SRS through the determined Tx beamforming.

Next, a beam failure recovery (BFR) process will be described.

In a beamformed system, Radio Link Failure (RLF) may occur frequently due to rotation, movement or blockage of the UE. Therefore, BFR is supported in NR to prevent frequent RLFs from occurring. BFR is similar to the radio link failure recovery process, and may be supported if the UE is aware of the new candidate beam(s). To detect beam failure, BS sets beam failure detection reference signals to the UE, which declares beam failure, when the number of beam failure indications from the physical layer of the UE reaches the threshold set by the RRC signalling within the period set by the RRC signalling of the BS. After beam failure has been detected, the UE triggers a beam failure recovery by initiating the random access process on the PCell; select an appropriate beam to perform the beam failure recovery (if the BS provides dedicated random access resources for certain beams, these are preferred by the UE). Upon completion of the random access procedure, the beam failure recovery is considered completed.

D. URLLC (Ultra-Reliable and Low Latency Communication)

URLLC transmission defined in NR may mean transmission for (1) relatively low traffic size, (2) relatively low arrival rate, (3) extremely low latency requirement (e.g., 0.5 and 1 ms), (4) relatively short transmission duration (e.g., 2 OFDM symbols), (5) urgent service/message, and the like. For UL, transmission for a particular type of traffic (e.g., URLLC) needs to be multiplexed with other pre-scheduled transmission (e.g., eMBB) in order to satisfy more stringent latency requirement. In this regard, one way is to inform the pre-scheduled UE that it will be preempted for a particular resource and to cause URLLC UE to use the corresponding resource in UL transmission.

For NR, dynamic resource sharing between eMBB and URLLC is supported. eMBB and URLLC services may be scheduled on non-overlapping time/frequency resources, and URLLC transmission may occur in resources scheduled for ongoing eMBB traffic. The eMBB UE may not know whether the PDSCH transmission of the corresponding UE was partially punctured, and because of corrupted coded bit, the UE may not be able to decode the PDSCH. Taking this into consideration, NR provides preemption indiction. The above preemption indication may be referred to as the interrupted transmission indication.

With respect to preemption indication, the UE receives the DownlinkPreemption IE through RRC signalling from the BS. When the UE is provided with DownlinkPreemption IE, for monitoring of the PDCCH carrying DCI format 2_1, the UE is set with the INT-RNTI provided by parameter int-RNTI in the DownlinkPreemption IE. The above UE is further set with a set of serving cells by INT-ConfigurationPerServing Cell containing a set of serving cell indexes provided by servingCellID and corresponding sets of locations for fields in DCI format 2_1 by positionInDCI, is set with information payload size for DCI format 2_1 by dci-payloadSize, and is set with indication granularity of time-frequency resources by timeFrequencySect.

The UE receives DCI format 2_1 from the BS on the basis of the DownlinkPreemption IE.

If the UE detects DCI format 2_1 for a serving cell in an established set of serving cells, it may be assumed that among the PRBs and sets of symbols in the last monitoring period before the monitoring period to which the DCI format 2_1 belongs transmits to the DCI format 2_1, none of PRBs and symbols indicated by the DCI format 2_1 transmits to the UE. For example, the UE regards a signal in a time-frequency resource indicated by the preemption as not a scheduled DL transmission to itself, and decodes the data based on the signals received in the remaining resource areas.

E. mMTC (Massive MTC)

Massive Machine Type Communication (mMTC) is one of 5G's scenarios to support hyper-connected services that communicate simultaneously with a large number of UEs. In this environment, the UE communicates intermittently with extremely low transmission speed and mobility. Therefore, mMTC makes the main goal of how long the UE can be operated at low cost. Regarding mMTC technology, 3GPP deals with MTC and NB (NarrowBand)-IoT.

The mMTC technology features repetitive transmission, frequency hopping, retuning, guard section or the like of PDCCH, PUCCH, PSCH (physical downlink shared channel), PUSCH, and the like.

That is, PUCCH (or PUCCH) containing specific information (or PUCCH (especially long PUCCH) or PRACH) and PDSCH (or PDCCH) containing responses to specific information are repeatedly transmitted. Repetitive transmission is performed via frequency hopping, for repetitive transmission, (RF) retuning is performed in a guard period from the primary frequency resource to the secondary frequency resource, and specific information and response to specific information are transmitted/received via narrowband (e.g., 6 RB (resource block) or 1 RB).

F. AI Basic Operation Using 5G Communication

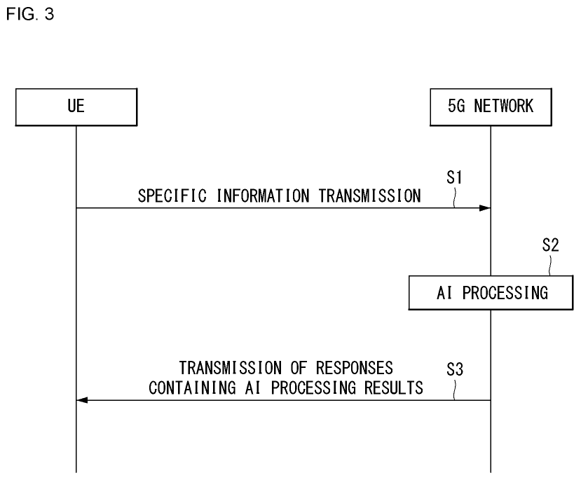

FIG. 3 shows an example of the basic operation of a 5G network and a user terminal in a 5G communication system.

UE transmits specific information transmission to the 5G network (S1). And, the 5G network performs 5G processing for the specific information (S2). Here, the 5G processing may include AI processing. In addition, the 5G network transmits responses containing AI processing results to the UE (S3).

G. Application Operation Between the User's Terminal and the 5G Network on a 5G Communication System

Hereinafter, AI operation using 5G communication will be more specifically described with reference to FIGS. 1 and 2, and wireless communication techniques (BM procedure, URLLC, Mmtc, and the like) discussed above.

First, the method proposed in this invention to be later described and the basic procedure of application operation applied by eMBB technology of 5G communication will be explained.

In order for the UE to transmit/receive signals, information or the like with 5G network, as in steps S1 and S3 of FIG. 3, the UE performs initial access procedures and random access procedures prior to stage S1 of FIG. 3 altogether with 5G network.

More specifically, the UE performs initial access procedures together with 5G network based on the SSB to acquire DL synchronization and system information. In the initial access process, a beam management (BM) process, a beam failure recovery process may be added, and quasi-co location (QCL) relationship may be added in the process of the UE receiving signals from 5G network.

The UE also performs random access procedures together with 5G network for UL synchronization acquisition and/or UL transmission. And, the above 5G network may transmit UL grant to schedule the transmission of specific information to the UE. Therefore, the UE transmits specific information to the 5G network based on the UL grant. And, the 5G network transmits DL grant to schedule the transmission of result of 5G processing on specific information to the UE. Therefore, the 5G network may transmit responses containing AI processing results to the UE based on the above DL grant.

Next, the method proposed in this invention to be later described and the basic procedure of application operation applied by URLLC technology of 5G communication will be explained.

As described above, after the UE performs the initial access procedure and/or the random access procedure altogether with 5G network, the UE may receive the DownlinkPreemption IE from the 5G network. And, the UE receives DCI format 2_1 containing pre-emption indication from the 5G network based on DownlinkPreception IE. In addition, the UE does not perform (or expect or assume) the receipt of eMBB data from resources (PRB and/or OFDM symbols) indicated by the pre-emption indication. Then, the UE may receive UL grant from the 5G network if it needs to transmit certain information.

Next, the method proposed in this invention to be later described and the basic procedure of application operation applied by mMTC technology of 5G communication will be explained.

The part of the steps of FIG. 3, which is changed by the application of the mMTC technology, will be mainly described.

In the stage S1 of FIG. 3, the UE receives UL grant from the 5G network in order to transmit certain information to the 5G network. Here, the UL grant may contain information on the number of repetitions for the transmission of specific information, which may be transmitted repeatedly based on information about the number of repetitions. That is, the UE transmits specific information to the 5G network based on the UL grant. And, repeated transmission of specific information may be made through frequency hopping, the first specific information may be transmitted at the first frequency resource, and the second specific information may be transmitted at the second frequency resource. The specific information may be transmitted through narrowband of 6RB (Resource Block) or 1RB (Resource Block).

5G communication technology described above may be combined with and applied to methods proposed in this to be described later, or may be provided to embody or clarify the technical features of the methods proposed in this invention.

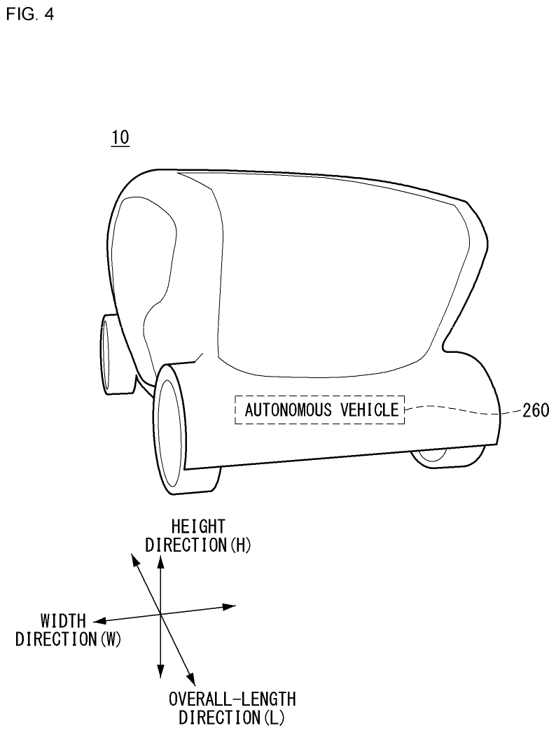

FIG. 4 is a drawing showing a vehicle according to an example of the disclosure.

Referring to FIG. 4, the vehicle 10 according to an example of the disclosure may be defined as a transporting means which drives on a road or a rail. The concept of the vehicle 10 includes an automobile, a train, and a motorbike. A vehicle (10) may be a concept that includes both an internal combustion engine vehicle equipped with an engine as a power source, a hybrid vehicle equipped with an engine and an electric motor as a power source, and an electric vehicle equipped with an electric motor as a power source. The vehicle 10 may be a vehicle owned by an individual. The vehicle 10 may be a shared vehicle. The vehicle 10 may be an autonomous vehicle.

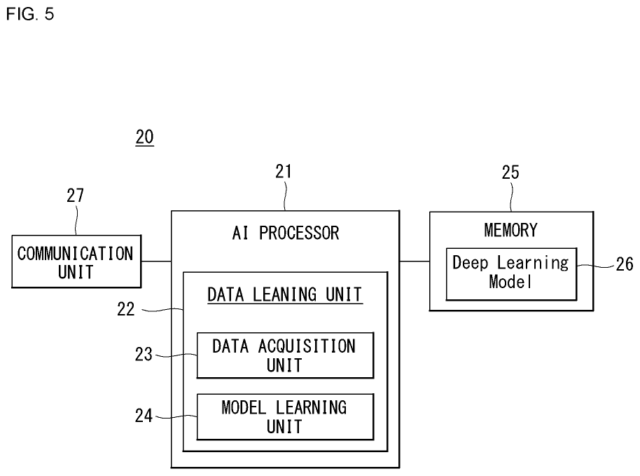

FIG. 5 is a block diagram of AI apparatus according to an example of the disclosure.

The AI apparatus 20 may include electronic devices containing AI modules capable of AI processing, or servers containing the AI modules. In addition, the AI apparatus 20 may be included in at least a partial configuration of the vehicle 10 as illustrated in FIG. 1 and be equipped to perform at least some of the AI processing together.

The AI processing may include all operations related to the driving of the vehicle 10 shown in FIG. 4. For example, autonomous vehicles may perform AI processing of sensing data or driver data to process/decide and generate control signals. Further, for example, autonomous vehicles can perform autonomous driving control by AI processing data acquired through interaction with other electronic devices equipped within the vehicles.

The AI apparatus 20 may include an AI processor 21, a memory 25, and/or a communication unit 27.

The AI apparatus 20 is a computing device that may learn neural networks and may be embodied by various electronic devices such as servers, desktop PCs, notebook PCs, tablet PCs, or the like.

The AI processor 21 may learn neural networks using programs stored in the memory 25. Specifically, the AI processor 21 may learn neural networks for recognizing vehicle-related data. Here, neural networks for recognizing vehicle-related data may be designed to simulate the structure of the human brain on a computer, and include multiple weighted network nodes that simulate the neurons of the human neural network. Multiple network modes may send and receive data according to each connection relationship to simulate the synaptic activity of a neuron sending and receiving signals through a synapse. Here, neural networks may include deep learning models developed from neural network models. In the deep-learning model, multiple network nodes are located in different layers and may send and receive data according to the convolution connection relationship. Examples of neural network models include deep neural networks (DNNs), convolutional deep neural networks (CNNs), Recurrent neural networks (RNNs), Restricted Boltzmann Machine (RBM), deep belief networks (DBNs), Deep Q-Network and the like, and may be applied to fields such as computer vision, voice recognition, natural language processing, voice/signal processing and the like.

Meanwhile, processors that perform the above-described functions may be general processors (e.g., CPU), but they may be AI-only processors (e.g., GPU) for artificial intelligence learning.

The memory 25 may store various programs and data that are needed for operation of the AI apparatus 20. The memory 25 may be embodied by nonvolatile memory, volatile memory, flash-memory, hard disk drive (HDD), solid state drive (SDD) or the like. The memory 25 may be accessed by the AI processor 21, and data may be read/recorded/modified/deleted/renewed by the AI processor 21. Further, the memory 25 may store neural network models (e.g., the deep learning model 26) generated via learning algorithms for data classification/recognition according to an example of this disclosure.

Meanwhile, the AI processor 21 may include a data learning unit 22 that learns the neural network for data classification/recognition. The data learning unit (22) may learn the criteria for which learning data is used to determine data classification/recognition and how data is classified and recognized using learning data. The data learning unit 22 may learn the deep learning model by acquiring the learning data to be used for learning and applying the acquired learning data to the deep learning model.

The data learning unit 22 may be manufactured in the form of at least one hardware chip and may be mounted on AI apparatus 20. For example, the data learning unit, 22 may be manufactured in the form of a dedicated hardware chip for artificial intelligence (AI), or manufactured as a part of a general processor (CPU) or a graphics-only processor (GPU) and be mounted on an AI apparatus 20. Further, the data learning unit 22 may be embodied by a software module. If embodied by a software module (or a program module containing instructions), the software module may be stored in a non-transitory readable recording media which can be read by computer. In this case, at least one software module may be provided by an operating system (OS) or by an application.

The data learning unit 22 may include the learning data acquisition unit 23 and the model learning unit 24.

The learning data acquisition unit 23 may acquire the learning data needed for neural network models to classify and recognize the data. For example, the learning data acquisition unit 23 is learning data, which may be acquired from vehicle data and/or sample data for input into the neural network model.

Using the above acquired learning data, the model learning unit 24 may learn to allow a neural network model to have criteria for determining how to classify predetermined data. At this time, the model learning unit 24 may make the neural network model learn via a supervised learning which uses at least some of the learning data as a basis for judgment. Alternatively, the model learning unit 24 may learn by itself using learning data without supervision, so that the neural network model is made learn via unsupervised learning which discovers judgment criteria. Further, the model learning unit 24 may make the neural network model learn via reinforcement learning by using feedback on whether the results of learning-based situational judgments are correct. Further, the model learning unit (24) may make a neural network model learn using learning algorithms that include error back-propagation or gradient descent.

Once the neural network model is learned, the model learning unit 24 may store the learned neural network model in a memory. The model learning unit 24 may store the learned neural network model in a memory of servers connected by a wired or wireless network with the AI apparatus 20.

The data learning unit 22 may further include a learning data preprocessing unit (not shown) and a learning data selecting unit (not shown) to improve the analysis results of the recognition model or to save time or resources required to create the recognition model.

The learning data preprocessing unit may preprocess the acquired data so that the acquired data can be used for learning for situation determination. For example, the learning data preprocessing unit may process the acquired data in the previously established format so that the model learning unit 24 can use the acquired learning data for learning for image recognition.

Further, the learning data selecting unit may select data necessary for learning from the learning data acquired in the learning data acquisition unit 23 and the learning data preprocessed in the pre-processing unit. Selected learning data may be provided to the model learning unit 24. For example, the learning data selecting unit may select data only for objects in a specific area by detecting specific areas of the image acquired through the vehicle's camera.

Further, the data learning unit 22 may further include a model evaluation unit (not shown) to improve the analysis results of the neural network model.

The model evaluation unit may make the model learning unit 22 learn again if the evaluation data is input into the neural network model and the analysis result output from the evaluation data does not meet the predetermined standard. In this case, the evaluation data may be data which have been already defined for evaluating the recognition model. For example, the model evaluation unit may evaluate that if the number or percentage of the evaluation data whose analysis result is not correct among the analysis results of the learned recognition model for the evaluation data, exceeds predetermined threshold, it does not meet the predetermined standard.

The communication unit 27 may transmit AI processing results by the AI processor 21 to external electronic devices.

Here, the external electronic device may be defined as an autonomous vehicle. Further, the AI apparatus 20 may be defined as another vehicle or 5G network communicating with said autonomous driving module vehicle. Meanwhile, the AI apparatus 20 may be functionally embedded in an autonomous driving module equipped in the vehicle to be embodied. Further, the 5G network may include servers or modules that perform autonomous driving-related controls. Further, the AI apparatus 20 may be embodied through a home server.

Meanwhile, the AI apparatus 20 shown in FIG. 5 is described by functionally dividing it into the AI processor 21 and the memory (25), the communication unit (27) and the like, but it should be noted that the aforementioned components may be integrated into a single module and referred to as an AI module.

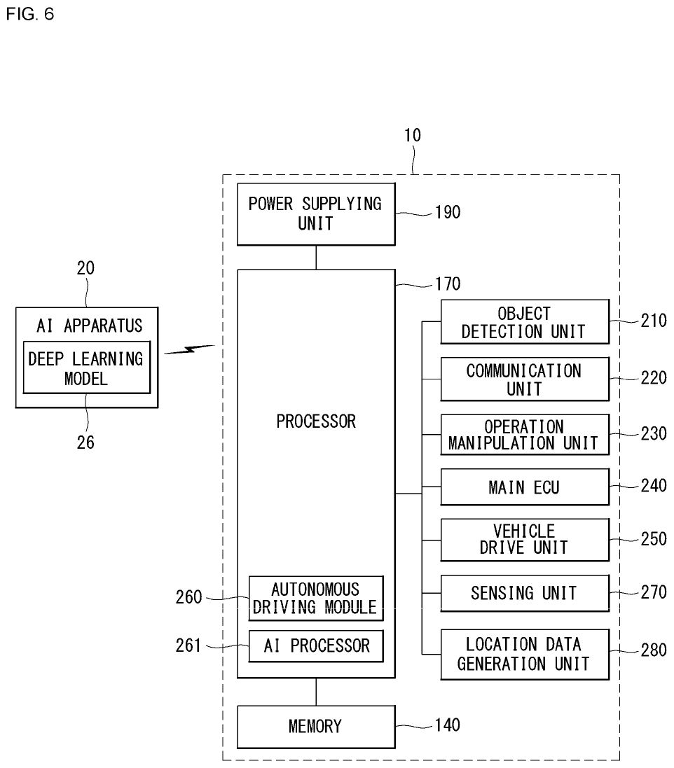

FIG. 6 is a drawing to describe the system in which autonomous driving vehicles and AI devices are connected, according to an example of the disclosure.

Referring to FIG. 6, the autonomous vehicle 10 may transmit data that requires AI processing to the AI apparatus 20 via the communication unit, and the AI apparatus 20 that include the deep learning model 26 may transmit AI processing results generated by using the deep learning model 26 to the autonomous vehicle 10. With regard to the AI apparatus 20, description made in FIG. 2 may be referred to.

The autonomous vehicle 10 may include a memory 140, a processor 170 and a power supplying unit 190, and the processor 170 may be further provided with an autonomous driving module 260 and an AI processor 261. Further, the autonomous vehicle 10 may include an interface that is wired or wirelessly connected to at least one electronic device provided within the vehicle to exchange data necessary for autonomous driving control. At least one electronic device connected through the interface may include an object detection unit 210, a communication unit 220, an operation manipulation unit 230, a main ECU 240, a vehicle drive unit 250, a sensing unit 270, and a location data generation unit 280.

The interface unit may be configured with at least one of a communication module, a terminal, a pin, a cable, a port, a circuit, an element, and device.

The memory 140 is connected electrically to the processor 170. The memory 140 may store basic data for units, control data for unit operation control and input/output data. The memory 140 may store data which has been processed by the processor 170. The memory 140 may be configured in hardware with at least one of ROM, RAM, EPROM, flash drive or hard drive. The memory 140 may store a variety of data for the entire operation of the autonomous vehicle 10, including programs for processing or control of the processor 170. The memory 140 may be embodied to be integral with the processor 170. According to an example, the memory 140 may be classified into a sub-configuration of the processor 170.

The power supplying unit 190 may supply power to the autonomous driving apparatus 10. The power supplying unit 190 may supply power to each unit of the autonomous vehicle 10 by receiving power from the power source (e.g. battery) contained in the autonomous vehicle 10. The power supplying unit 190 may be operated according to the control signal provided by the main ECU 240. The power supplying unit 190 may include a switched-mode power supply (SMPS).

The processor 170 may be electrically connected to the memory 140, the interface 280, and the power supplying unit 190 to exchange signals. The processor 170 may be embodied using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electric units for performing other function.

The processor 170 may be driven by power supplied from the power supplying unit 190. The processor 170 may receive data, process data, and generate signals, and provide signals, in a state where power is supplied by the power supplying unit 190.

The processor 170 may receive information from other electronic apparatus within the autonomous vehicle 10 via the interface. The processor 170 may provide control signals to other electronic apparatus within the autonomous vehicle 10 via the interface.

The autonomous vehicle 10 may include at least one printed circuit board (PCB). The memory 140, the interface, the power supplying unit 190 and the processor 170 may be electrically connected to the printed circuit board.

Hereinafter, other electronic apparatus within the vehicle connected to the interface, the AI processor 261 and the autonomous driving module 260 will be described more in detail. Hereinafter, for the convenience of explanation, the autonomous vehicle 10 will be referred to as vehicle 10.

First, the object detection unit 210 may generate information about objects outside the vehicle 10. By applying a neural network model to data acquired through object detection unit 210, the AI processor 261 may generate at least one of the existence of an object, location information of the object, distance information of the vehicle and the object, and relative speed information of the vehicle and the object.

An object detection unit 210 may include at least one sensor capable of detecting objects outside the vehicle 10. The sensor may include at least one of cameras, radars, LiDARs, ultrasonic sensors and infrared sensors. The object detection unit 210 may provide data for the object created based on sensing signals generated by the sensor to at least one electronic device included in the vehicle.

Meanwhile, the vehicle 10 transmits data acquired from at least one sensor to the AI apparatus 20 via the communication unit 220, and the AI apparatus 20 may transmit to the vehicle 10 AI processing data generated by applying a neural network model 26 to the delivered data. The vehicle 10 recognizes information for the detected objects based on the AI processing data received, and the autonomous driving module 260 may perform autonomous driving control operation using the information recognized.

The communication unit 220 may exchange signals with a device located outside the vehicle 10. The communication unit 220 may exchange signals with at least one of an infrastructure (e.g., server, broadcasting station), other vehicle, and a terminal. The communication unit 220 may include at least one of transmitting antennas, receiving antennas, Radio Frequency (RF) circuits and RF devices that can embody various communication protocols, in order to perform communication.

By applying a neural network model to data acquired through object detection unit 210, at least one of the existence of an object, location information of the object, distance information of the vehicle and the object, and relative speed information of the vehicle and the object may be generated.

The operation manipulation unit 230 is a device that receives user input for operation. In a manual mode, the vehicle 10 may be driven based on signals provided by the operation manipulation unit 230. The operation manipulation unit 230 may include a steering input apparatus (e.g., steering wheel), an acceleration input apparatus (e.g., accelerator pedal), and brake input devices (e.g., brake pedal).

Meanwhile, in an autonomous driving mode, the AI processor 261 may generate input signals of the operation manipulation unit 230 according to the signals for controlling vehicle movement based on a driving plan generated via the autonomous driving module 260.

Meanwhile, the vehicle 10 transmits data necessary for controlling of the operation manipulation unit 230 to the AI apparatus 20 via the communication unit 220, and the AI apparatus 20 may transmit to the vehicle 10 AI processing data generated by applying a neural network model 26 to the delivered data. The vehicle 10 may use for movement control of the vehicle the input signals of the operation manipulation unit 230 based on the AI processing data received.

The main ECU 240 may control general operation of the at least one electronic apparatus provided within the vehicle 10.

The vehicle drive unit 250 is an apparatus which electrically control various vehicle driving apparatuses within the vehicle 10. The vehicle drive unit 250 may include a powertrain drive control apparatus, a chassis drive control apparatus, a door/window drive control apparatus, a safety apparatus drive control apparatus, a lamp drive control apparatus and an air conditioning drive control apparatus. The powertrain drive control apparatus may include a driving force source control apparatus and a transmission drive control apparatus. The chassis drive control apparatus may include a steering wheel drive control apparatus, a brake drive control apparatus and a suspension drive control apparatus. On the other hand, the safety apparatus drive control apparatus may include a safety belt drive control apparatus for seat belt control.

The vehicle drive unit 250 includes at least one electronic control unit (e.g., the Electronic Control Unit (ECU)).

The vehicle drive unit 250 may control a powertrain, a steering apparatus and a brake apparatus based on signals received from the autonomous driving module 260. The signal received from the autonomous driving module 260 may be a drive control signal generated from the AI processor 261 by applying a neural network model to vehicle related data. The drive control signal may be signals received from an external AI apparatus 20 via the communication unit 220.

The sensing unit 270 may sense conditions of the vehicle. The sensing unit 270 may include at least any one of a Inertial Measurement Unit (IMU) sensor, a crash sensor, a wheel sensor, a speed sensor, a slope sensor, a weight sensor, a heading sensor, a position module, a vehicle forward/rearward sensor, a battery sensor, a fuel sensor, a tire sensor, a steering sensor, a temperature sensor, a humidity sensor, an ultrasonic sensor, an illumination sensor, a pedal position sensor. Meanwhile, the initial measurement unit (IMU) sensor may include one or more of an acceleration sensor, a gyro sensor and a magnetic sensor.

By applying a neural network model to sensing data generated by at least one sensor, the AI processor 261 may generate condition data of the vehicle. The AI processing data generated by the neural network model may include vehicle attitude data, vehicle motion data, vehicle yaw data, vehicle roll data, vehicle pitch data, vehicle impact data, vehicle direction data, vehicle angle data, vehicle speed data, vehicle acceleration data, vehicle acceleration data, vehicle inclination data, vehicle forward/rearward data, vehicle weight data, battery data, fuel data, tire pressure data, vehicle internal temperature data, humidity data in the vehicle, steering wheel rotation angle data, external illumination data, data for pressure on the accelerator pedal, data for pressure on the brake pedal, and the like.

The autonomous driving module 260 may generate a driving control signal based on the AI processed vehicle condition data.

Meanwhile, the vehicle 10 transmits sensing data acquired from at least one sensor to the AI apparatus 20 via the communication unit 22, and the AI apparatus 20 may transmit to the vehicle 10 AI processing data generated by applying a neural network model 26 to the delivered sensing data.

The location data generation unit 280 may generate location data of the vehicle 10. The location data generation unit 280 may include at least any one of a Global Positioning System (GPS) and Differential Global Positioning System (DGPS).

By applying a neural network model to location data generated by at least one location data generation apparatus, the AI processor 261 may generate more accurate location data of the vehicle.

According to an example, the AI processor 261 may perform deep-learning calculation based on at least one of the camera images of the Inertial Measurement Unit (IMU) of the sensing unit 270 and the object detection apparatus 210, and calibrate location data based on generated AI processing data.

Meanwhile, the vehicle 10 transmits the location data acquired from the location data generation unit 280 to the AI apparatus 20 via the communication unit 220, and the AI apparatus 20 may transmit to the vehicle 10 AI processing data generated by applying a neural network model 26 to the location data received.

The vehicle 10 may include an internal communication system 50. A plurality of electronic devices provided in the vehicle 10 may exchange signals via the internal communication system 50. Data may be included in the signal. The internal communication system 50 may use at least one communication protocol (e.g., CAN, LIN, FlexRay, MOST, Ethernet).

Based on the data acquired, the autonomous driving module 260 may generate a path for autonomous driving and create a driving plan for driving along the generated path.

The autonomous driving module 260 may embody at least one Advanced Driver Assistance System (ADAS) function. The ADAS may embody at least any one of a Adaptive Cruise Control (ACC) system, an Automatic Emergency Braking (AEB) system, a Forward Collision Warning (FCW) system, a Lane Keeping Assist (LKA) system, a Lane Changing Assist (LCA) system, a Target Following Assist (TFA) system, a Blind Spot Detection (BSD) system, an Adaptive High Beam Control (HBA: high beam assist) system, an Auto Parking System (APS), a Pedestrian Collision Warning System, a Traffic Sign Recognition (TSR) System, a Traffic Sign Assist (TSA) system, a Night Vision System (NV), Driver Status Monitoring (DSM) system and a Traffic Jam Assist (TJA) system.

The AI processor 261 may transmit control signals capable of performing at least one of the ADAS functions to the autonomous driving module 260 by applying to the neural network model at least one sensor equipped with the vehicle, traffic-related information received from an external device, and information received from other vehicles communicating with the vehicle above.

Further, the vehicle 10 may transmit to the AI apparatus 20 at least one data to perform ADAS functions via the communication unit 220, and the AI apparatus 20 may apply the neural network model 260 to the data received, thereby transmitting to the vehicle 10 control signals that can perform the ADAS function.

The autonomous drive module 260 acquires driver status information and/or vehicle condition information via the AI processor 261, and based on this, switching from an autonomous driving mode to a manual driving mode or switching from a manual driving mode to an autonomous driving mode may be performed.

Meanwhile, the vehicles 10 may use in driving control AI processing data for supporting passengers. For example, as described above, at least one sensor provided in the vehicle may be used to check the conditions of the driver and passenger.

Alternatively, the vehicle 10 may recognize the voice signals of the driver or passenger, perform a voice processing operation and perform a voice synthesis operation, through the AI processor 261.

In the above, the 5G communication required to embody the vehicle control method in accordance with an example of the disclosure, and schematic description for performing the AI processing by applying the 5G communication and transmitting and receiving AI processing results have been discussed.

5G communication technology described above may be combined with and applied to methods proposed in this to be described later, or may be provided to embody or clarify the technical features of the methods proposed in this invention.

Hereinafter, various embodiments of the invention will be described with reference to accompanying drawings.

Deep Neural Network (DNN) Model

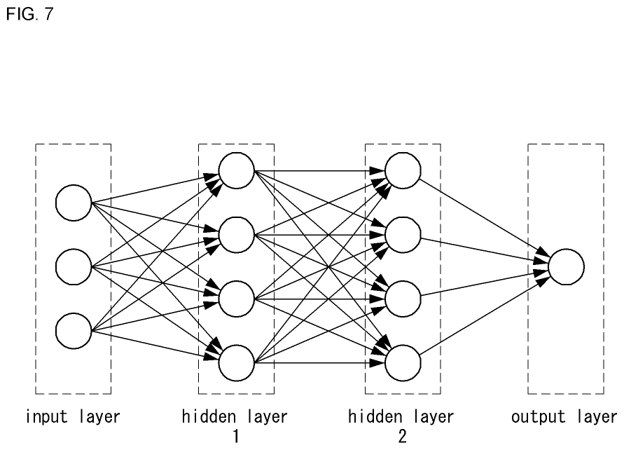

FIG. 7 is an example of the DNN model to which the invention may be applied.

The Deep Neural Network (DNN) is an artificial Neural Network (ANN) formed with several hidden layers between an input layer and an output layer. The Deep Neural Networks may model complex non-linear relationships, as in a typical artificial neural networks.

For example, in the deep neural network structure for an object identification model, each object may be represented by a hierarchical configuration of the image basic elements. At this time, the additional layers may aggregate the characteristics of the gradually gathered lower layers. This feature of deep neural networks allows more complex data to be modeled with fewer units (nodes) than similarly performed artificial neural networks.

As the number of hidden layers increases, the artificial neural network is called “deep,” and machine learning paradigm that uses such a sufficiently deepened artificial neural network as a learning model is called deep learning. And, the sufficiently deep artificial neural network used for such deep learning is commonly referred to as the Deep Neural network (DNN).

In this disclosure, the sensing data of vehicle 10 or the data required for autonomous driving may be input into the input layer of DNN, and as they go through the hidden layers, meaningful data that can be used for autonomous driving can be generated through the output layer.

The specification of the disclosure commonly refers to the artificial neural network used for this deep learning method as the DNN, but other methods of deep learning may be applied as long as meaningful data can be output in a similar way.

As autonomous vehicles become generalized, idle autonomous vehicles will affect traffic volume of road. Increase in such idle vehicles may cause vast waste of expense. In addition, in a point of view of a user, when attempting to use a sharing vehicle, a problem that abnormal waiting time is caused after calling may take place.

The invention may infer state information of a user through a home IoT (Internet of Things), may learn the state information of a user to set a going out intention stage (three stages), and move a sharing vehicle stepwisely to a geographical range having a center at the user according to such going out intention levels. In addition, via the home IoT, it is possible to allocate a vehicle matching for clothes of a user, to let a sharing vehicle to wait in front of a house of a user (preliminary passenger) and ask in advance the user (preliminary passenger) whether to board or not, when the user has completed going out, and it is possible to analyze a pattern of going out, boarding or not boarding of the user (preliminary passenger), learn a behavior pattern of the user and reflect it to a geographical range setting for vehicle call. For this, the above-described AI technology may be used.

Through this, it is possible for the invention to attract potential customers (passengers), thus decrease waste of idle vehicle, and create additional profits. Further, it is also possible to prevent traffic congestion due to decrease in idle vehicles, and to guarantee satisfaction of the service use due to decrease in waiting time upon vehicle call in a viewpoint of a user. At the same time, by guiding a vehicle matching with clothes of a user, additional satisfaction can be obtained, and it is intended to propose a driving solution which analyzes in real time a going out intention of a preliminary user via the home IoT, and move an idle autonomous vehicle stepwisely according to a preparation state stage.

Home Internet of Things (IoT)

The home IoT, which the invention may be applied to, means a technology which embeds sensors and a communication function into various kinds of objects in our home to connect them to the Internet, and which connects various kinds of objects with each other via a wireless communication. Such wireless communication may be formed with the above-described 5G communication system or in a way similar to it. The things connected by the Internet may give and receive data, analyze it, and provide learning information to a user, by themselves, or the user may remotely control it. For this, the AI technology may be used through the AI apparatus 20. Here, the things includes various embedded system, such as a home appliance, a mobile equipment, a wearable device and the like. The things connected to the Internet of Things must be connected to the Internet with their unique IP addresses which can identify themselves, and may have sensors embedded therein to acquire data from external environments.

Collection Information

The invention collects the state information of a user for determining the going out intention of the user, via the home IoT. Such state information may include a user identifier, location information of a user, thing information, or thing usage information. The location information of a user may indicate the current location of the user, and the thing information may a unique identifier for the thing (e.g., a bathroom, a room, a living room, a front door, bed use, sofa use, a shoe rack, a wardrobe or the like). Moreover, the thing information may be information about the thing that the user is now using, and may determine and indicate whether the user is using the thing or not through a sensor attached to the corresponding thing.

Inferring Method of Current Condition of a User

The AI apparatus 20 may predict the current state of a user, based on the state information of a user collected.

### Example 1: In a Case where the Current State of a User is Predicted as Having a Rest

In a case where it is determined that the user is located at a region outside a bed room, based on the location information of the user, and does not use a bed, based on the thing usage information;

### Example 2: In a Case where the Current State of a User is Predicted as Taking a Shower

In a case where it is determined that the user is located in the bath room, based on the location information of the user, and the light of the bath room is turned on, or the shower is used, based on the thing usage information;

Examples besides the aforementioned Examples may be defined, and Examples 1 and 2 may be redefined as needed.

Going Out Intention Stage Determination Setting Method

The going out intention of a user may be stepwisely defined according to the current state of the user. In a case where the current state of the user corresponds to a predetermined action sequence for going out of a user, a going out intention stage may be set. The going out intention stage, for example, may be defined as follows.

(1) Interest Stage

It is a lowest stage in the going out intention stage of a user, and means a case where the current state of the user is a state of not sleeping. For example, in a case where the current state of the user is predicted as having a rest and there is a schedule which the user previously recorded, the going out intention stage may be set as the interest stage from going out preparation time (e.g., one hour) learned through user behavior analysis, before going out time which can be predicted according to the schedule information.

(2) Progress Stage

It means a case where state information related to going out intention of the user is additionally sensed in the interest stage. For example, it means a case where the current state is determined as taking a shower or taking off clothes via the state information of the user, or a case where the user is determined as being located at the front door.

As the number of occurrence of the state information related to the going out intention of the user is preset, the progress stage may be set by the number of the state information occurrence being completed. For example, in a case where taking shower state information occurrence (1/3 pass), taking-off clothes state information occurrence (2/3 pass), and front door location state information occurrence (3/3 pass) are completed, the progress stage may be set. Additionally, the sequence of the user state information occurrence may be taken into consideration.

(3) Decision Stage

It is a stage in which the going out of the user is decided, and may be set in a case where the current state of the user is determined as going out.

Stages besides the aforementioned stages may be defined, and corresponding steps may be redefined as needed.

Method of Allocating/Moving a Vehicle According to the Going Out Intention Stage

The state information according to the behavior of the user is monitored and collected to be transmitted to the AI apparatus 20 through the home IoT. The AI apparatus 20 determines the going out intention stage of the user based the collected usage information.

In a case where the going out intention stage of the user is set as the interest stage, vehicle allocation requests are transmitted to idle vehicles that can be provided to the user within an appropriate time. The appropriate time may be varied through pattern learning about a period of time taken until the user goes out, a user going out intention action or the like.

The vehicle 10, which has received the vehicle allocation request, sets the geographical range according to the going out intention stage of the user, taking into consideration the travel distance between the user and the vehicle 10. The setting of the geographical range is set by learning the boarding records of the user in the AI processor 261. The idle vehicle which received the allocation vehicle request for the first time may set its own position as a first geographical range.

For example, in a case where the going out intention stage of the user enters state information occurrence of the progress stage, the vehicle 10 may reset the geographical range from the first geographical range into the second geographical range, and may move to a position corresponding to the second geographical range. In a case where the setting of the progress stage is completed, the vehicle 10 may be reset from the second geographical range into the third geographical range, and may move to a position corresponding to the third geographical range. By the stepwise resetting of the geographical range and the stepwise movement of the vehicle 10 to the reset geographical range, the vehicle 10 may be allowed to wait for a plurality of users, and approach gradually toward a specific user, whereby efficient vehicle allocation may be performed.

In a case where the going out intention stage of the user is set to the decision stage, the vehicle 10 may inform the user of the waiting state of the vehicle 10 through a terminal of the user or the like, and ask whether to board or not. In this case, the AI apparatus 20 may further inform through the state information during taking off clothes so that the vehicle 10 matching with the clothes can be allocated first based on the clothes information selected by the user. For example, further information may be made, such that a luxury sedan vehicle can be allocated to a user in suit, and such that a usual vehicle can be allocated to a user in casual wear. For this, a server may manage information about types of the vehicles 10, give the vehicles priority ranking values, and thus make the vehicle having highest priority ranking be allocated.

In a case where the user accepts boarding by selecting the vehicle 10, the server may inform a boarding position, a vehicle information, fares, a distance and time to the destination, or the like.

If the user rejects boarding, the vehicle 10 is classified into an idle vehicle for other users and wait.

This behavior pattern of the user (e.g., the state information, boarding acceptance information) may be transmitted to the AI server and the AI processor 261 to be used as input values for learning about the going out intention pattern of the user and geographical range setting reference of the vehicle 10.

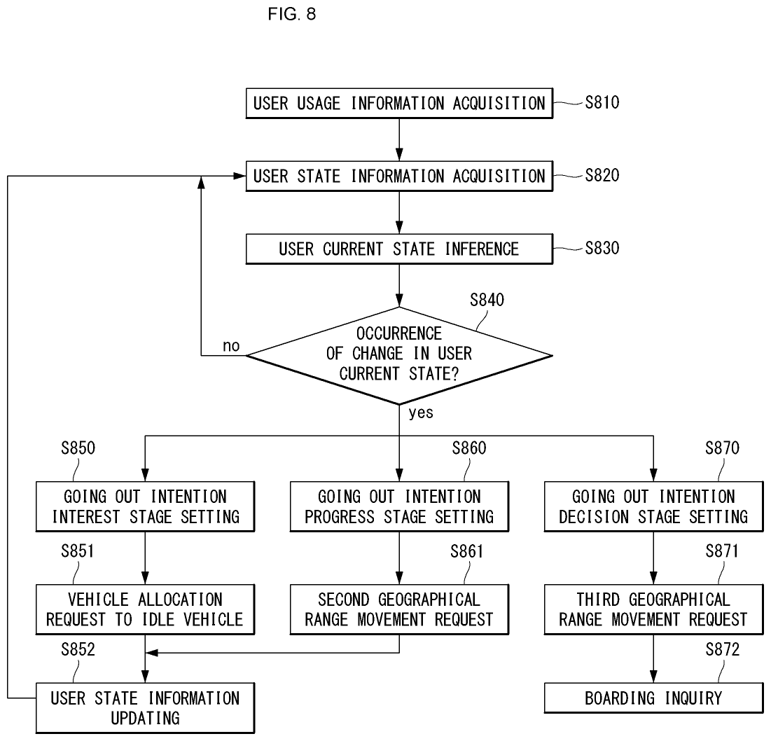

FIG. 8 is an example to which the invention may be applied.

The server, in which the AI apparatus 20 is included, may perform operations as follows using user state information acquired through the home IoT.

The server acquires usage information of an identified user through the user state information (S810). In the usage information, predicted preparation time of the user, user schedule information and user preference vehicle information which the AI apparatus 20 has learned may be included. Such usage information may be stored and managed on a memory in the server, or transmitted from the home server. In the example of the disclosure, the corresponding usage information may be performed first one time, and may be received from the vehicle 10 and updated when the driving service provided by the vehicle 10 is completed.

The server acquires the state information of the user using the home IoT (S820).

The AI apparatus 20 infers the current state of the user based on the state information of the user acquired (S830).

It determines whether change occurs or not by comparing the current state of the user acquired with the previous current state (S840). If no change occurs, process is performed again from the user state information acquisition stage, while in a case where any change occurs, the going out intention stage is set according to the user current state.

In a case where the user current state may be set to the going out intention interest stage according to the above-described setting method, the user going out intention is set to the interest stage (S850).

The server executes vehicle allocation request for the user to the idle vehicles connected (S851). In this case, the vehicle 10 may be set to the above-described first geographical range.

The user state information is updated to acquired user state information (S852).

If the user current state may be set to the going out intention progress stage, the user going out intention is set to the progress stage (S860).

The server may request the corresponding vehicle 10 to move to the second geographical range (S861).

In addition, the previous user state information will be updated to the corresponding state information (S852).

In a case where the user current state may be set to the going out intention decision stage according to the above-described setting method, the user going out intention is set to the decision stage (S870).

The server may request the corresponding vehicle 10 to move to the third geographical range (S871).

And through the user's terminal or the like, the user may be asked whether to board the allocated vehicle 10 (S872). When the user sets boarding, the server may transmit a vehicle allocation completion message to the vehicle 10.

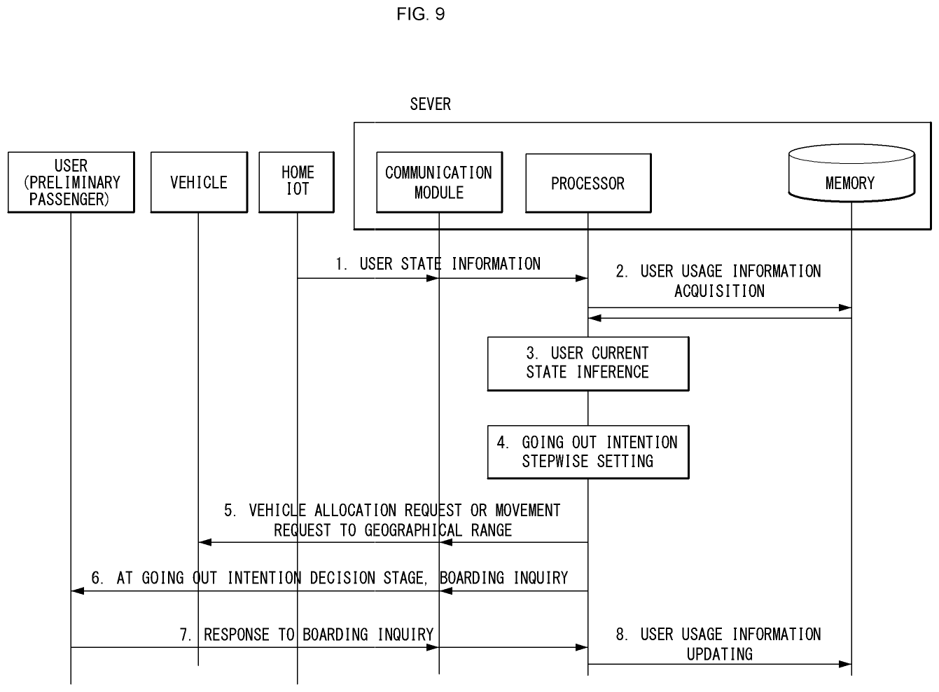

FIG. 9 is an example to which the invention may be applied.

The corresponding server may include a communication module, a processor, and a memory, and the processor may perform the above-described AI apparatus 20 function or may include the AI apparatus 20.

1. The processor acquires the state information of the user which the home IOT has monitored, through the communication module.

2. Through the user identifier in the state information, the processor acquires the user usage information within the memory.

3. The processor may infer the current state of the user through a deep learning model with the user state information and the characteristic values of the usage information as input values, using the AI technology.

4. Based on the user current state inferred, the going out intention of the user may be stepwisely set.

5. According to the going out intention stage set, the server may request the vehicles 10, which can be allocated to the user, to be allocated or to move to the above-described geographical range.

6. If the going out intention of the user is set to the decision stage, that is, the final stage, the processor asks the user whether to board or not through a communication module.

7. The user transmits a response message to the boarding inquiry.

8. The processor may update the usage information according to the response message of the user.

General Apparatus to which the Invention May be Applied

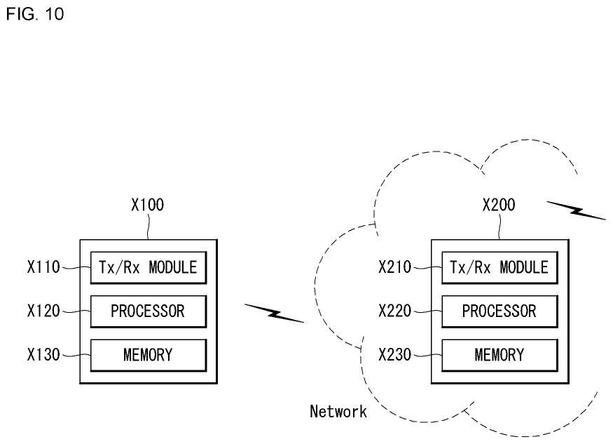

Referring to FIG. 10, the server X200 in accordance with a proposed implementation example may include a communication module X210, a processor X220, and a memory X230. The communication module X210 may be referred to as a radio frequency (RF) unit. The communication module X210 may be configured to transmit various signals, data and information to external apparatuses and to receive various signals, data and information from external apparatuses. The server X200 may be wiredly and/or wirelessly connected with the external apparatuses. The communication module X210 may be embodied to be separated into a transmission unit and a reception unit. The processor X220 may control the overall operation of the server X200 and may be configured to perform a function of computing and processing information or the like which the server X200 will transmit and receive to and from the external apparatuses. In addition, the processor X220 may be configured to perform the server operation proposed in the invention. The processor X220 may control the communication module X110 to transmit data or messages to the UE or other vehicle or other server according to the proposal of the invention. The memory X230 may store computed and processed information, or the like for a predetermined period of time and may be replaced by a component such as a buffer.

Further, the specific configurations of such terminal apparatus X100 and server X200 may be embodied, such that items described in the various exemplary embodiments of the invention are applied independently or two or more exemplary embodiments are applied at the same time, and duplicate contents will be omitted for clarity.

### EXAMPLES TO WHICH THE INVENTION MAY BE APPLIED

### Example 1

A vehicle allocation method of a server in an automated vehicle and highway system, the vehicle allocation method comprising: acquiring state information of a user, using a home Internet of Things (IoT); extracting a characteristic value from the state information; inputting the characteristic value into a learned deep neural network (DNN) classifier, and determining behavior information of the user from an output of the deep neural network; setting a going out stage related to an action sequence for going out of the user, based on the behavior information; and transmitting a vehicle allocation request message to the vehicle in order for the user to use the vehicle, based on the going out stage, wherein the vehicle allocation request message contains a movement request message for moving the vehicle.

### Example 2

The vehicle allocation method of claim 1, wherein the state information includes location information of the user, thing information of a space in which the user is located, and information indicating whether the user uses the thing, and is periodically generated via the home Internet of Things (IoT).

### Example 3

The vehicle allocation method of claim 1, wherein the going out stage includes a first stage indicating that the user is prior to start of going out preparation, a second stage indicating that the going out preparation is in progress, or a third stage indicating that the going out preparation is completed, and wherein the going out preparation is based on schedule information set by the user.

### Example 4

The vehicle allocation method of claim 3, wherein the movement request message indicates a movement toward a point within a predetermined distance range from a location point of the user based on the going out stage.

### Example 5

The vehicle allocation method of claim 3, wherein the second stage is set in a case where it is determined that the user performed one or more actions related to the action sequence.

### Example 6

The vehicle allocation method of claim 4, wherein in a case the going out stage is updated, the predetermined distance range indicates a predetermined distance range that is closer from the location point of the user than the predetermined distance range indicated at the previous going out stage.

### Example 7

The vehicle allocation method of claim 3, further comprising: in a case where the going out stage is set to the third stage, transmitting a message asking whether to board the vehicle or not to a terminal of the user; and receiving a response message to the message asking whether to board or not, wherein the usage information of the user is updated, based on the response messages.

### Example 8

The vehicle allocation method of claim 7, wherein in a case where the response message indicates boarding rejection of the user, the vehicle is set to an idle vehicle.

### Example 9

The vehicle allocation method of claim 7, further comprising: in a case where the response message indicates boarding acceptance of the user, transmitting information on a boarding location of the vehicle, information of the vehicle, usage fee of the vehicle, a travel distance or a necessary time to the user's destination to the terminal.

### Example 10

The vehicle allocation method of claim 1, further comprising: determining clothes information of the user based on the state information, using the above DNN model; and setting a priority value of the vehicle related to the clothes information, wherein the setting of the priority value sets the higher the priority value for a vehicle of a vehicle type at a higher class as the clothes of the user is more formal.

### Example 11

The vehicle allocation method of claim 5, wherein the movement request message contains a message for controlling a movement speed of the vehicle based on time when the user performs an action related to the action sequence.

### Example 12

The vehicle allocation method of claim 6, wherein the predetermined distance range can be updated using the behavior information related to the going out stage.

### Example 13

A server providing a vehicle allocation method in an automated vehicle and highway system, the server comprising: a communication module; a memory; and a processor, wherein the processor acquires state information of a user, using a home Internet of Things (IoT), extracts s characteristic value from the state information, inputs the characteristic value into a learned deep neural network (DNN) classifier, and determines behavior information of the driver from an output of the deep neural network, sets a going out stage related to an action sequence for going out of the user, based on the behavior information, and transmits a vehicle allocation request message to the vehicle in order for the user to use the vehicle, through the communication module, based on the going out stage, wherein the vehicle allocation request message contains a movement request message for moving the vehicle.

### Example 14

The server of claim 13, wherein the state information includes location information of the user, thing information of a space in which the user is located, and information indicating whether the user uses the thing, and is periodically generated via the home Internet of Things (IoT).

### Example 15

The server of claim 13, wherein the going out stage includes a first stage indicating that the user is prior to start of going out preparation, a second stage indicating that the going out preparation is in progress, or a third stage indicating that the going out preparation is completed, and wherein the going out preparation is based on schedule information set by the user.

### Example 16

The server of claim 15, wherein the movement request message indicates a movement toward a point within a predetermined distance range from a location point of the user based on the going out stage.

### Example 17

The server of claim 15, wherein the second stage is set in a case where it is determined that the user performed one or more actions related to the action sequence.

### Example 18

The server of claim 16, wherein in a case the going out stage is updated, the predetermined distance range indicates a predetermined distance range that is closer from the location point of the user than the predetermined distance range indicated at the previous going out stage.

### Example 19

The server of claim 15, wherein, through the communication module, the processor transmits a message asking whether to board or not to a terminal of the user and receives a response message to the message asking whether to board or not, and wherein the usage information of the user managed in the memory is updated based on the response messages.

### Example 20

The server of claim 19, wherein in a case where the response message indicates boarding rejection of the user, the processor sets the vehicle to an idle vehicle.

### Example 21

The server of example 19, wherein if the response message indicates boarding acceptance of the user, the processor transmits information on a boarding location of the vehicle, information of the vehicle, usage fee of the vehicle, a travel distance or a necessary time to the user's destination to the terminal through the communication module.

### Example 22

The server of example 13, wherein the processor determines clothes information of the user, using the DNN models, based on the state information, and sets s priority value of the vehicles in relation to the clothes information, and wherein the more formal the clothes of the user are, the higher the priority value for a vehicle of a vehicle type at a higher class is.

### Example 23

The vehicle allocation method of claim 17, wherein the movement request message contains a message for controlling a movement speed of the vehicle based on time when the user performs an action related to the action sequence.

### Example 24

The vehicle allocation method of claim 18, wherein the predetermined distance range may be updated using the behavior information related to the going out stage.

The disclosure described above may be embodied as a computer-readable code in a medium in which program is recorded. A computer-readable medium includes all kinds of recorders where data that can be read by a computer system is stored. Examples of computer-readable media are hard disk drives (HDDs), solid state disks (SSDs), Silicon disk drives (SDDs), ROMs, RAMs, CD-ROMs, magnetic tape, floppy disks, optical data storage devices, and the like, and include implementation in the form of carrier waves (e.g., transmission over the Internet). Therefore, the detailed description above should not be interpreted in a limited way but should be considered as an example. The scope of the invention shall be determined by a reasonable interpretation of the claims attached, and all changes within the equivalent range of the invention are within the scope of the invention.

Further, in the above examples of service and implementation are described mainly, but these are only examples and do not limit the invention, and a person having an ordinary skill in the art to which the invention belongs are able to know a number of variations and applications not exemplified above are possible without departing from the essential characteristics of the service and implementation example. For example, each component specified in the implementation example can be modified to perform. And, these variants and their application-related differences should be interpreted as being within the scope of the invention as defined in the claims attached.

### INDUSTRIAL APPLICABILITY

While the invention has been described mainly with regard to an example applied to automated vehicle & highway systems on the basis of 5G (5 generation), it is also possible to apply it to various wireless communication systems and autonomous driving apparatuses besides this.

1. A vehicle allocation method of a server in an automated vehicle and highway system, the vehicle allocation method comprising:
acquiring state information of a user, using a home Internet of Things (IoT);
extracting a characteristic value from the state information;
inputting the characteristic value into a learned deep neural network (DNN) classifier, and determining behavior information of the user from an output of the deep neural network;
setting a going out stage related to an action sequence for going out of the user, based on the behavior information; and
transmitting a vehicle allocation request message to the vehicle in order for the user to use the vehicle, based on the going out stage,
wherein the vehicle allocation request message contains a movement request message for moving the vehicle.

2. The vehicle allocation method of claim 1, wherein the state information includes location information of the user, thing information of a space in which the user is located, and information indicating whether the user uses the thing, and is periodically generated via the home Internet of Things (IoT).

3. The vehicle allocation method of claim 1, wherein the going out stage includes a first stage indicating that the user is prior to start of going out preparation, a second stage indicating that the going out preparation is in progress, or a third stage indicating that the going out preparation is completed, and
wherein the going out preparation is based on schedule information set by the user.

4. The vehicle allocation method of claim 3, wherein the movement request message indicates a movement toward a point within a predetermined distance range from a location point of the user based on the going out stage.

5. The vehicle allocation method of claim 3, wherein the second stage is set in a case where it is determined that the user performed one or more actions related to the action sequence.

6. The vehicle allocation method of claim 4, wherein in a case the going out stage is updated, the predetermined distance range indicates a predetermined distance range that is closer from the location point of the user than the predetermined distance range indicated at the previous going out stage.

7. The vehicle allocation method of claim 3, further comprising: in a case where the going out stage is set to the third stage,
transmitting a message asking whether to board the vehicle or not to a terminal of the user; and
receiving a response message to the message asking whether to board or not,
wherein the usage information of the user is updated, based on the response messages.

8. The vehicle allocation method of claim 7, wherein in a case where the response message indicates boarding rejection of the user, the vehicle is set to an idle vehicle.

9. The vehicle allocation method of claim 7, further comprising: in a case where the response message indicates boarding acceptance of the user,
transmitting information on a boarding location of the vehicle, information of the vehicle, usage fee of the vehicle, a travel distance or a necessary time to the user's destination to the terminal.

10. The vehicle allocation method of claim 1, further comprising:
determining clothes information of the user based on the state information, using the above DNN model; and
setting a priority value of the vehicle related to the clothes information,
wherein the setting of the priority value sets the higher the priority value for a vehicle of a vehicle type at a higher class as the clothes of the user is more formal.

11. The vehicle allocation method of claim 5, wherein the movement request message contains a message for controlling a movement speed of the vehicle based on time when the user performs an action related to the action sequence.

12. The vehicle allocation method of claim 6, wherein the predetermined distance range can be updated using the behavior information related to the going out stage.

13. A server providing a vehicle allocation method in an automated vehicle and highway system, the server comprising:
a transceiver;
a memory; and
a processor,
wherein the processor
acquires state information of a user, using a home Internet of Things (IoT),
extracts s characteristic value from the state information,
inputs the characteristic value into a learned deep neural network (DNN) classifier, and determines behavior information of the driver from an output of the deep neural network,
sets a going out stage related to an action sequence for going out of the user, based on the behavior information, and
transmits a vehicle allocation request message to the vehicle in order for the user to use the vehicle, through the transceiver, based on the going out stage,
wherein the vehicle allocation request message contains a movement request message for moving the vehicle.

14. The server of claim 13, wherein the state information includes location information of the user, thing information of a space in which the user is located, and information indicating whether the user uses the thing, and is periodically generated via the home Internet of Things (IoT).

15. The server of claim 13, wherein the going out stage includes a first stage indicating that the user is prior to start of going out preparation, a second stage indicating that the going out preparation is in progress, or a third stage indicating that the going out preparation is completed, and
wherein the going out preparation is based on schedule information set by the user.

16. The server of claim 15, wherein the movement request message indicates a movement toward a point within a predetermined distance range from a location point of the user based on the going out stage.

17. The server of claim 15, wherein the second stage is set in a case where it is determined that the user performed one or more actions related to the action sequence.

18. The server of claim 16, wherein in a case the going out stage is updated, the predetermined distance range indicates a predetermined distance range that is closer from the location point of the user than the predetermined distance range indicated at the previous going out stage.

19. The server of claim 15, wherein, through the transceiver, the processor transmits a message asking whether to board or not to a terminal of the user and receives a response message to the message asking whether to board or not, and
wherein the usage information of the user managed in the memory is updated based on the response messages.

20. The server of claim 19, wherein in a case where the response message indicates boarding rejection of the user, the processor sets the vehicle to an idle vehicle.
